(19) United States
(12) Patent Application Publication
(10) Pub. No.: US 2014/0039850 A1
(43) Pub. Date: Feb. 6, 2014

(54) METHOD AND APPARATUS OF FORMING SOLAR RADIATION MODEL APPLYING TOPOGRAPHICAL EFFECTS

(71) Applicants: Joon-Bum Jee, Seoul (KR); Kyu-Tae Lee, Gangneung-si (KR); Young-Jean Choi, Seoul (KR); Il-Sung Zo, Gangneung-si (KR)

(72) Inventors: Joon-Bum Jee, Seoul (KR); Kyu-Tae Lee, Gangneung-si (KR); Young-Jean Choi, Seoul (KR); Il-Sung Zo, Gangneung-si (KR)

(21) Appl. No.: 13/565,976

(22) Filed: Aug. 3, 2012

(51) Int. Cl. G06F 17/10

(52) U.S. Cl. 703/2

(57) ABSTRACT

Provided are a method and an apparatus of forming a solar radiation model applying topographical effects, the method comprising: calculating a slope angle and a slope aspect of a selected point on a digital elevation model data; calculating a final direct solar radiation of the selected point; calculating a final diffuse solar radiation of the selected point using the slope angle of the selected point, a sky-view factor of the selected point, and a diffuse solar radiation on the horizontal surface of the selected point; and calculating a global solar radiation using the final direct solar radiation and the final diffuse solar radiation.

### BACKGROUND OF THE INVENTION

1. Field of the Invention

Exemplary embodiments of the present invention relates to a method and an apparatus of forming a solar radiation, more specifically, to a method and an apparatus of forming a solar radiation model applying topographical effects.

2. Description of the Related Arts

Solar radiation is a primary driving force that moves the earth's atmosphere, and an essential energy source for all living things on the earth. This solar radiation energy and the change thereof have been variously utilized for researches, industrial activities and the like in the fields of agriculture, biology, medication and architecture as well as atmosphere sciences.

An apparatus for observing the solar radiation energy is called a solar radiation sensor. Using this apparatus, a solar radiation that reaches the earth's surface is observed. However, it is problematic that the solar radiation sensor is very difficult to manage and correct, and is limited in an observable area, compared to other meteorological instruments. Accordingly, as a method of confirming the distribution of solar radiation into a broad area, a solar radiation model is used.

The solar radiation model is a method of calculating a process, in which energy emitted from the sun is attenuated by gas (ozone, vapor and the like), aerosol, cloud and the like during passing through the atmosphere and reaching the earth's surface, using theoretical parameterization. This parameterization model has been importantly used in global, meso scale models and the like, and particularly, has largely helped to produce a photovoltaic energy map according to each country in weather leading countries and develop new and renewable energy. The NREL (National Renewable Energy Laboratory) of U.S.A. has produced a photovoltaic energy map at 40 km resolution based on the CSR (Climatological Solar Radiation) model (Maxwell et al., 1998; George and Maxwell, 1999; Perez et al., 2002), and has currently partially enhanced the resolution up to 10 km. Furthermore, the German and Australian Weather Services have also developed the photovoltaic energy map using a solar radiation model and satellite data (Michael et al., 1978; Weymouth and Marshall, 1999).

However, most of the solar radiation models have performed only the calculation on a horizontal plane. Thus, it is disadvantageous that when the topography is complex, a large error between a solar energy that really reaches the earth's surface and a calculated solar energy is generated.

### SUMMARY OF THE INVENTION

In an aspect of the present invention, there is provided a solar radiation model capable of deriving the nearest result to a really observed value from calculating a direct solar radiation and a diffuse solar radiation by reflecting the shading and blocking of solar energy caused by the surrounding topography to calculate a solar energy reaching the earth's surface, which is used as important base information for making out a photovoltaic energy map, evaluating the efficiency of photovoltaic power generation equipment and evaluating an influence of the surrounding topography in observing a solar radiation, and is applied to researches and developments related to the topography.

In accordance with an aspect of the present invention, there is provided a method of forming a solar radiation model applying topographical effects comprising: calculating a slope angle and a slope aspect of a selected point on digital elevation model data; calculating a final direct solar radiation of the selected point using the slope angle of the selected point, a direct solar radiation on a horizontal surface of the selected point, and a shading angle shading sunlight due to an angle between a solar zenith angle of the selected point and a vertical line of a slope surface of the selected point, and topographical elements of the selected point; calculating a final diffuse solar radiation of the selected point using the slope angle of the selected point, a sky-view factor of the selected point, and a diffuse solar radiation on the horizontal surface of the selected point; and calculating a global solar radiation using the final direct solar radiation and the final diffuse solar radiation.

In accordance with another aspect of the present invention, there is provided an apparatus of forming a solar radiation model applying topographical effect comprising: a slope calculating unit for calculating a slope angle and a slope aspect of a selected point on digital elevation model data; a direct solar radiation calculating unit for calculating a final direct solar radiation of the selected point using the slope angle of the selected point, a direct solar radiation on a horizontal surface of the selected point, and a shading angle shading sunlight due to an angle between a solar zenith angle of the selected point and a vertical line of a slope surface of the selected point, and topographical elements of the selected point; a diffuse solar radiation calculating unit for calculating a final diffuse solar radiation of the selected point using the slope angle of the selected point, a sky-view factor of the selected point, and a diffuse solar radiation on the horizontal surface of the selected point; and a global solar radiation calculating unit for calculating a global solar radiation using the final direct solar radiation and the final diffuse solar radiation.

In accordance with exemplary embodiments of the present invention, it can be provided with the solar radiation model capable of deriving the nearest result to a really observed value from calculating a direct solar radiation and a diffuse solar radiation by reflecting the shading and blocking of solar energy caused by the surrounding topography to calculate a solar energy that reaches the earth's surface, which is used as important base information for making out a photovoltaic energy map, evaluating the efficiency of photovoltaic power generation equipment according to the topography, and evaluating an influence of the surrounding topography in observing a solar radiation, and are applied to researches and development related to topography.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flow chart for explaining a method of forming a solar radiation model applying topographical effects according to an exemplary embodiment of the present invention.

FIG. 2 is a view illustrating digital elevation model data according to another exemplary embodiment of the present invention.

FIG. 3 is a view for explaining direct solar radiation according to still another exemplary embodiment of the present invention.

FIG. 4 is a view for explaining diffuse solar radiation according to still another exemplary embodiment of the present invention.

FIG. 5 is a construction view illustrating an apparatus of forming a solar radiation model applying topographical effects according to still another exemplary embodiment of the present invention.

### DETAILED DESCRIPTION OF THE INVENTION

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Same reference numerals presented in each drawing represent same elements.

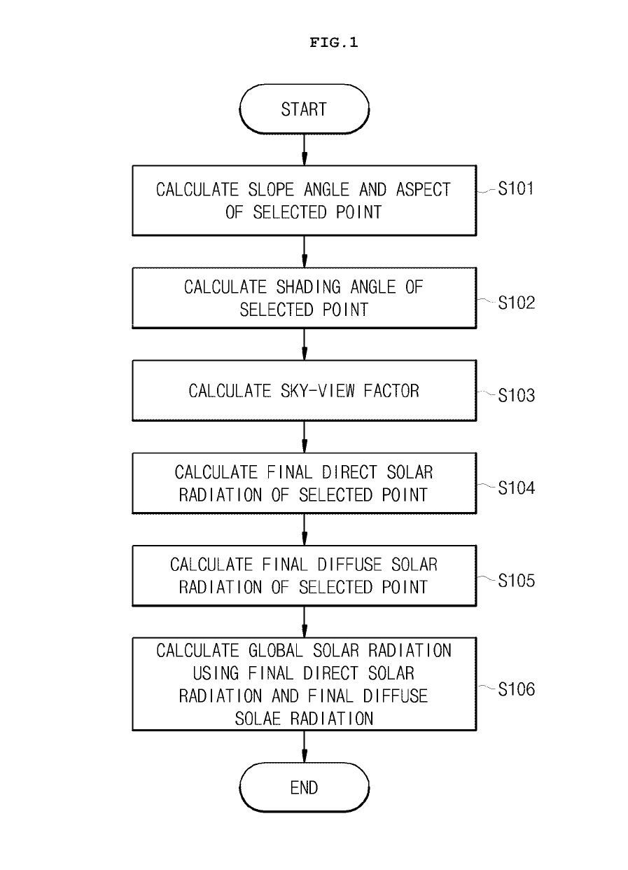

FIG. 1 is a flow chart for explaining a method of forming a solar radiation model applying topographical effects according to an exemplary embodiment of the present invention. A method of forming a solar radiation model applying topographical effects according to an exemplary embodiment of the present invention is explained with reference to FIG. 1.

For the observation of solar energy reaching the earth's surface, pyranometers installed in an observatory are used. Most of them are installed on a horizontal surface. When observing, surrounding shading is qualitatively confirmed, but is difficult to quantitatively evaluate. However, the influence thereof may be theoretically calculated. If there are an accurate altitude and distance information about the surrounding topography, the shading and blocking of solar energy caused by the topography may be calculated, and an effect caused by the topography may be quantitatively evaluated by applying them to a solar radiation model.

As an observation technology has been recently developed and data has been accumulated, digital elevation model (DEM) data with high resolution may be obtained. In the case where the high resolution data are used, an influence of the surrounding topography may be theoretically applied. Values in which an altitude, a slope and an aspect of the topography have an influence may be calculated using a formula.

Global solar radiation reaching the earth's surface is calculated in a state of being divided into direct solar radiation and diffuse solar radiation and is calculated by following Math Formula 1.

I=I_{dλ} cos θ+I_{sλ} [Math Formula 1]

Sunlight reaching the earth's surface is absorbed and diffused by cloud, aerosol and gaseous components in the atmosphere. At this time, the features according to each wavelength are important, and the solar radiation model is calculated depending on the wavelengths. According components, the solar radiation model is divided into a direct radiation I_{dir} component and a diffuse radiation I_{dif} component. A global radiation I_{glo} component is resulted from adding a solar zenith angle θ to the two components.

I_{glo}=I_{dir} cos θ+I_{dif} [Math Formula 2]

The solar radiation model of math formula 2 may be formed using the direct radiation component and the diffuse radiation component calculated as shown above. In the solar radiation model, information about the surrounding topography of an observation point is not calculated, and thus it is necessary to perform a three dimensional calculation including the solar zenith angle and the azimuth angle.

For this, according to the present exemplary embodiment of the invention, a slope angle and a slope aspect of a selected point on digital elevation model (DEM) data are calculated (S101).

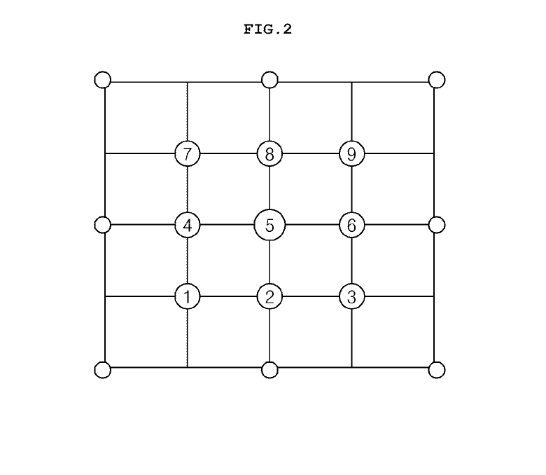

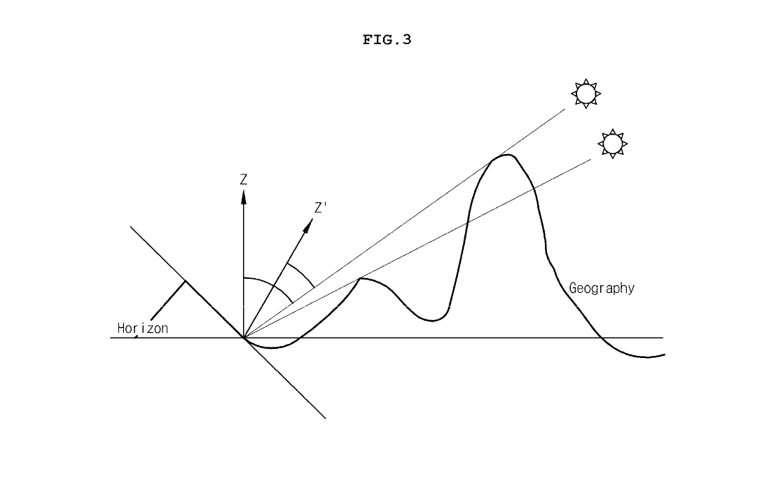

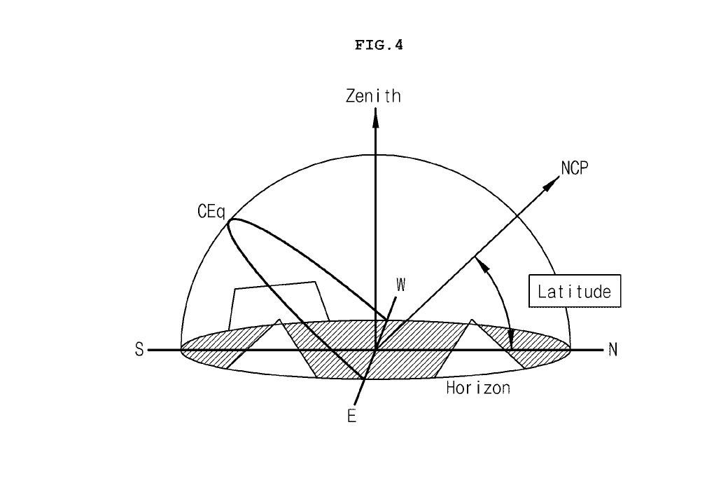

FIG. 2 is a view illustrating digital elevation model (DEM) data according to another exemplary embodiment of the present invention. FIG. 3 is a view for explaining direct solar radiation according to still another exemplary embodiment of the present invention. FIG. 4 is a view for explaining diffuse solar radiation according to still another exemplary embodiment of the present invention.

As illustrated in FIG. 2, on the assumption that the digital elevation model data has a grid shape of an x-axis from east to west and a y-axis from south to north, which is located at an equal distance in the x-axis and y-axis directions, the selected point is each grid point on the grid, and a slope β and a slope aspect φ at grid point ‘5’ are calculated by math formula 3.

$$β = {tan}^{- 1} \sqrt{{( \frac{d z}{d x} )}^{2} + {( \frac{d z}{d y} )}^{2}} \\ φ = 270 ° + {tan}^{- 1} ( - \frac{\frac{d z}{d x}}{\frac{d z}{d y}} ) - 90 ° \frac{\frac{d z}{d y}}{\vert \frac{d z}{d y} \vert} \qquad [ Math Formula 3 ]$$

wherein

$$\frac{d z}{d x}$$

represents a slope gradient of an altitude from east to west, and

$$\frac{d z}{d y}$$

represents a slope gradient of an altitude from south to north.

Furthermore,

$$\frac{d z}{d x} and \frac{d z}{d y}$$

may be calculated by following math formula 4.

$$\frac{d z}{d x} = \frac{( {z}_{3} - {z}_{1} ) + 2 ( {z}_{6} - {z}_{4} ) + ( {z}_{9} - {z}_{7} )}{8 d x}$$

$$\frac{d z}{d y} = \frac{( {z}_{7} - {z}_{1} ) + 2 ( {z}_{8} - {z}_{2} ) + ( {z}_{9} - {z}_{3} )}{8 d y}$$

wherein z₁, z₂, z₃, z₄, z₅, z₆, z₇, z₈ and z₉ represent a location of each grid point as illustrated in FIG. 2.

Since then, a shading angle which is an angle shading sunlight due to topographical elements of the selected point is calculated (S102).

At this time, the shading angle is calculated using a distance of the selected point and a difference between altitudes. More specifically, the shading angle Hᵢ (φ) is calculated by following math formula 5.

$${H}_{i} ( φ ) = {tan}^{- 1} ( \frac{{x}_{i} - {x}_{0}}{{z}_{i} - {z}_{0}} ) \qquad [ Math Formula 5 ]$$

wherein x₀ represents a distance of the selected point, z₀ represents an altitude of the selected point, zᵢ represents an altitude of the solar shading topography, φ represents an aspect of the solar shading topography, and xᵢ represents is a distance of the solar shading topography.

Here, θ_{T}>90° means the self-shading of direct sunlight caused by the topography itself of a calculated point, and θ₀>Hᵢ(φ) means the shading of direct sunlight caused by the topography that is xᵢ distant from the calculated point.

Since then, a sky-view factor which is a ratio of the sky not covered by the topographical elements to the sky of the selected point is calculated using the shading angle (S103).

The sky-view factor V is a sky-view factor, and represents an influence of the surrounding topography on the calculation of diffuse sunlight as a value between 0 and 1, and is calculated as shown in following math formula 6.

$$V = \frac{1}{2 π} [ {\int }_{φ - {φ}_{n} = π / 2}^{3 π / 2} {sin}^{2} {γ}_{1} d ( {φ}_{0} - φ ) + {\int }_{φ - {φ}_{n} = - π / 2}^{π / 2} {sin}^{2} {γ}_{2} d ( {φ}_{0} - φ ) \qquad [ Math Formula 6 ]$$

wherein β represents a slope angle, φ represents an azimuth angle, φ₀ represents an azimuth angle of a slope surface of the calculated point.

That is, the sky-view factor of said math formula 6 is 1 when an observed point does not generate the shading of a diffuse solar radiation in all directions, and the larger the degree of the shading is generated, the sky-view factor becomes close to 0. In this formula, γ₁ and γ₂ are shown in following math formula 7.

$${γ}_{1} = Min [ H + λ , \frac{π}{2} ] \\ {γ}_{2} = Max [ H + λ , 0 ] \qquad [ Math Formula 7 ]$$

wherein H represents the shading angle calculated in math formula 5 and means a shading angle to the azimuth angle of the calculated point, and λ is expressed by following math formula 8.

λ=tan⁻¹ [tan β cos(φ−φₙ)] [Math Formula 8]

wherein β represents the slope angle, and φ represents the azimuth angle.

Since then, a final direct solar radiation of the selected point is calculated using the shading angle calculated in math formula 5 (S104).

At this time, the final direct solar radiation of the selected point is calculated using the slope angle of the selected point, a direct solar radiation on a horizontal surface of the selected point, an angle between the solar zenith angle of the selected point and a vertical line of a slope surface of the selected point, and the shading angle.

Explaining more specifically, the final direct solar radiation calculated in a state of including the topographical effects is calculated by following math formula 9.

$${B}_{dir} = \frac{{I}_{dir}}{cos β} \frac{cos {θ}_{T}}{cos θ} \qquad [ Math Formula 9 ]$$

wherein I_{dir} represents a direct solar radiation on a horizontal surface, β represents the slope angle, and θ_{T} represents an angle between the solar zenith angle and the vertical line of the slope surface of the calculated point, more specifically, which is calculated as shown in following math formula 10.

cos θ_{T}=sin β sin θ cos(φ₀−φ)+cos β cos θ [Math Formula 10]

wherein φ₀ represents the azimuth angle, φ means the azimuth angle of the slope surface of the selected point (a clockwise rotation angle from south to the slope surface of the slope angle β).

Since then, a final diffuse solar radiation of the selected point is calculated using the sky-view factor V calculated in math formulas 6 to 8 (S105).

At this time, the final diffuse solar radiation of the selected point is calculated using the slope angle of the selected point, the sky-view factor of the selected point and the diffuse solar radiation on the horizontal surface of the selected point.

Explaining more specifically, the final diffuse solar radiation calculated in a state of including the topographical effects is calculated by following math formula 11.

$${B}_{dif} = V \frac{{I}_{dif}}{cos β} \qquad [ Math Formula 11 ]$$

wherein I_{dif} represents the diffuse solar radiation on the horizontal surface, V represents the sky-view factor, and β represents the slope angle.

Since then, a global solar radiation is calculated using the final direct solar radiation and the final diffuse solar radiation (S106), and the detailed calculation method thereabout is shown in following math formula 12.

B_{glo}=B_{dir} cos θ+B_{dif} [Math Formula 12]

wherein B_{dir} represents the final direct solar radiation, B_{dif} represents the final diffuse solar radiation, θ represents the solar zenith angle, and B_{glo} represents the global solar radiation.

Accordingly, in accordance with the present exemplary embodiment of the invention, it can be provided with the solar radiation model capable of deriving the nearest results to a really observed value from calculating the direct solar radiation and the diffuse solar radiation by reflecting the shading and blocking of solar energy caused by the surrounding topography to calculate the solar energy reaching the earth's surface.

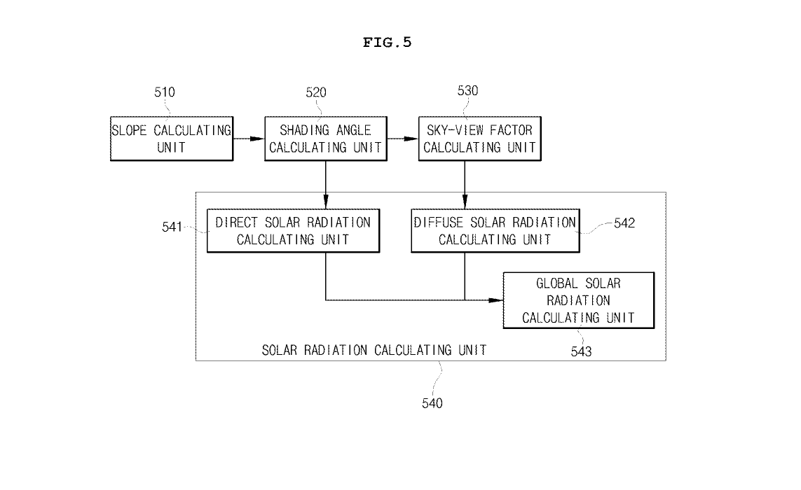

FIG. 5 is a construction view illustrating an apparatus of forming a solar radiation model applying topographical effects according to still another exemplary embodiment of the present invention. The apparatus of forming the solar radiation model applying topographical effects according to the present exemplary embodiment of the invention is explained with reference to FIG. 5.

As illustrated in FIG. 5, the apparatus of forming the solar radiation model applying topographical effects according to the present exemplary embodiment of the invention includes a slope calculating unit 510, a shading angle calculating unit 520, a sky-view factor calculating unit 530 and a solar radiation calculating unit 540, a direct solar radiation calculating unit 541, a diffuse solar radiation calculating unit 542 and a global solar radiation calculating unit 543.

The slope calculating unit 510 calculates the slope angle and slope aspect of the selected point on the digital elevation model data. At this time, the digital elevation model data divides the topography into grid shapes in an x-axis direction from east to west and a y-axis direction from south to north. Furthermore, the selected point means each grid point on the grid.

The shading angle calculating unit 520 calculates the shading angle that is an angle shading sunlight due to topographical elements of the selected point. The shading angle calculating unit 520 calculates the shading angle using a distance of the selected point and a difference between altitudes.

The sky-view factor calculating unit 530 calculates a sky-view factor, which is a ratio of the sky not covered by the topographical elements to the sky of the selected point, using the shading angle.

The direct solar radiation calculating unit 541 calculates the final direct solar radiation of the selected point using the slope angle of the selected point, the direct solar radiation on the horizontal surface of the selected point, the angle between the solar zenith angle of the selected point and the vertical line of the slope surface of the selected point, and the shading angle.

The diffuse solar radiation calculating unit 542 calculates the final diffuse solar radiation using the slope angle of the selected point, the sky-view factor of the selected point, and the diffuse solar radiation on the horizontal surface of the selected point.

The global solar radiation calculating unit 543 calculates the global solar radiation using the final direct solar radiation and the final diffuse solar radiation. The global solar radiation calculating unit 543 may calculate the global solar radiation considering the topographical effects by adding the final direct solar radiation to the final diffuse solar radiation.

Meanwhile, to drive the solar radiation model according to the present exemplary embodiment of the invention, various input data such as ozone data, aerosol data, precipitable water data, the earth's surface albedo data, atmospheric pressure data, temperature data and the like are required. Among these data, the atmospheric pressure data and precipitable water data have used RDAPS (Regional Data Assimilation and Prediction System) data of 10 km resolution, the ozone data have used OMI (Ozone Monitoring Instrument) sensor data of 1°×1° resolution, and the aerosol data have used data prepared by the MODIS (Moderate Resolution Imaging Spectroradiometer) sensor. Furthermore, the albedo data have used 0.05°×0.05° resolution data prepared by the MODIS sensor, and the altitude data of the calculated point have used 3 seconds (90 m×90 m) data of SRTM (Shuttle Radar Topographic Mission). In addition, as to the cases that the Korean Peninsula is clear and cloudy, a solar radiation at 4 km resolution has been calculated using a GWNU model and data prepared based on the solar radiation theory as mentioned above.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

What is claimed is:

1. A method of forming a solar radiation model applying topographical effects comprising:
calculating a slope angle and a slope aspect of a selected point on a digital elevation model data;
calculating a final direct solar radiation of the selected point using the slope angle the selected point, a direct solar radiation on a horizontal surface of the selected point, and a shading angle shading sunlight due to an angle between a solar zenith angle of the selected point and a vertical line of a slope surface of the selected point, and topographical elements of the selected point;
calculating a final diffuse solar radiation of the selected point using the slope angle of the selected point, a sky-view factor of the selected point, and a diffuse solar radiation on the horizontal surface of the selected point; and
calculating a global solar radiation using the final direct solar radiation and the final diffuse solar radiation.

2. The method of claim 1, wherein the digital elevation model data divides the topography into grid shapes in an x-axis direction from east to west and a y-axis direction from south to north, and the selected point is each grid point on the grid.

3. The method of claim 1, wherein the calculating of the slope angle and slope aspect of the selected point calculates the slope angle and the slop aspect using the following math formula:
$$β = {tan}^{- 1} \sqrt{{( \frac{d z}{d x} )}^{2} + {( \frac{d z}{d y} )}^{2}}$$
$$φ = 270 ° + {tan}^{- 1} ( - \frac{\frac{d z}{d x}}{\frac{d z}{d y}} ) - 90 ° \frac{\frac{d z}{d y}}{\vert \frac{d z}{d y} \vert}$$
wherein β represents the slope angle, φ represents an azimuth angle,
$$\frac{d z}{d x}$$
represents a slope gradient of an altitude from east to west, and
$$\frac{d z}{d y}$$
represents a slope gradient of an altitude from south to north.

4. The method of claim 3, wherein the
$$\frac{d z}{d x} and \frac{d z}{d y}$$
are calculated using following math formula:
$$\frac{d z}{d x} = \frac{( {z}_{3} - {z}_{1} ) + 2 ( {z}_{6} - {z}_{4} ) + ( {z}_{9} - {z}_{7} )}{8 d x}$$
$$\frac{d z}{d y} = \frac{( {z}_{7} - {z}_{1} ) + 2 ( {z}_{8} - {z}_{2} ) + ( {z}_{9} - {z}_{3} )}{8 d y}$$
wherein z₁, z₂, z₃, z₄, z₅, z₆, z₇, z₈ and z₉ represent a location of each grid point.

5. The method of claim 1, wherein the calculating of the final direct solar radiation further comprises calculating a shading angle using a distance of the selected point and a difference between altitudes.

6. The method of claim 5, wherein the calculating of the shading angle calculates using the following math formula:
$${H}_{i} ( φ ) = {tan}^{- 1} ( \frac{{x}_{i} - {x}_{0}}{{z}_{i} - {z}_{0}} )$$
wherein x₀ represents a distance of the selected point, z₀ represents an altitude of the selected point, zᵢ represents an altitude of the solar shading topography, φ represents an aspect of the solar shading topography, and xᵢ represents is a distance of the solar shading topography.

7. The method of claim 1, wherein the calculating of the final direct solar radiation calculates using the following math formula:
$${B}_{dir} = \frac{{I}_{dir}}{cos β} \frac{cos {θ}_{T}}{cos θ}$$
wherein I_{dir} is the direct solar radiation on the horizontal surface of the selected point, cos θ_{T}=sin β sin θ cos(φ₀−φ)+cos β cos θ, β represents the slope angle, φ represents the azimuth angle, and φ₀ represents an azimuth angle of a slope surface of a calculated point.

8. The method of claim 1, wherein the calculating of the final diffuse solar radiation calculates using the following math formula:
$${B}_{dif} = V \frac{{I}_{dif}}{cos β}$$
wherein I_{dif} represents the diffuse solar radiation on the horizontal surface, V represents the sky-view factor, and β represents the slope angle.

9. The method of claim 1, wherein the calculating of the final diffuse solar radiation further comprises calculating a sky-view factor, which is a ratio of the sky not covered by topographical elements to the sky of the selected point, using the shading angle.

10. The method of claim 1, wherein the calculating of the sky-view factor calculates using the following math formula:
$$V = \frac{1}{2 π} [ {\int }_{φ - {φ}_{n} = π / 2}^{3 π / 2} {sin }^{2} {γ}_{1} d ( {φ}_{0} - φ ) + {\int }_{φ - {φ}_{n} = - π / 2}^{π / 2} {sin}^{2} {γ}_{2} d ( {φ}_{0} - φ )$$
wherein
$${γ}_{1} = Min [ H + λ , \frac{π}{2} ] , {γ}_{2} = Max [ H + λ , 0 ] ,$$
H represents the shading angle to the azimuth angle of the selected point, λ=tan⁻¹ [tan β cos(φ−φₙ)], β represents the slope angle, φ represents the azimuth angle, and φ₀ represents the azimuth angle of the slope surface of the calculated point.

11. The method of claim 1, wherein the calculating of the global solar radiation calculates using the following math formula:
B_{glo}=B_{dir} cos θ+B_{dif}
wherein B_{dir} represents the final direct solar radiation, B_{dif} represents the final diffuse solar radiation, θ represents the solar zenith angle.

12. An apparatus of forming a solar radiation model applying topographical effects comprising:
a slope calculating unit for calculating a slope angle and a slope aspect of a selected point on digital elevation model data;
a direct solar radiation calculating unit for calculating a final direct solar radiation of the selected point using the slope angle the selected point, a direct solar radiation on a horizontal surface of the selected point, and a shading angle that is an angle shading sunlight due to an angle between a solar zenith angle of the selected point and a vertical line of a slope surface of the selected point, and topographic elements of the selected point;
a diffuse solar radiation calculating unit for calculating a final diffuse solar radiation of the selected point using the slope angle of the selected point, a sky-view factor of the selected point, and a diffuse solar radiation on the horizontal surface of the selected point; and
a global solar radiation calculating unit for calculating a global solar radiation using the final direct solar radiation and the final diffuse solar radiation.

13. The apparatus of claim 12, wherein the digital elevation model data divides the topography into grid shapes in an x-axis direction from east to west and a y-axis direction from south to north, and the selected point is each grid point on the grid.

14. The apparatus of claim 12, further comprising a shading angle calculating unit for calculating a shading angle using a distance of the selected point and a difference between altitudes.

15. The apparatus of claim 12, further comprising a sky-view factor calculating unit for calculating a sky-view factor which is a ratio of the sky not covered by topographical elements to the sky of the selected point.

16. The apparatus of claim 12, wherein the global solar radiation calculating unit calculates using the following math formula:
B_{glo}=B_{dir} cos θ+B_{dif}
wherein B_{dir} represents the final direct solar radiation, B_{dif} represents the final diffuse solar radiation, θ represents the solar zenith angle.
